(19) United States
(12) Patent Application Publication
(10) Pub. No.: US 2011/0131341 A1
(43) Pub. Date: Jun. 2, 2011

(54) SELECTIVE CONTENT PRE-CACHING

(75) Inventors: Won Suk Yoo, Redmond, WA (US); Venkat Raman Don, Redmond, WA (US); Anil K. Ruia, Issaquah, WA (US); Ning Lin, Redmond, WA (US); Chittaranjan Pattekar, Boethell, WA (US)

(73) Assignee: Microsoft Corporation, Redmond, WA (US)

(21) Appl. No.: 12/626,957

(22) Filed: Nov. 30, 2009

(51) Int. Cl. G06F 15/16

(52) U.S. Cl. 709/237; 709/230; 709/223

(57) ABSTRACT

A selective pre-caching system reduces the amount of content cached at cache proxies by limiting the cached content to that content that a particular cache proxy is responsible for caching. This can substantially reduce the content stored on each cache proxy and reduces the amount of resources consumed for pre-caching in preparation for a particular event. The cache proxy receives a list of content items that and an indication of the topology of the cache network. The cache proxy uses the received topology to determine the content items in the received list of content items that the cache proxy is responsible for caching. The cache proxy then retrieves the determined content items so that they are available in the cache before client requests are received.

### BACKGROUND

One of the techniques for achieving high scalability for Internet content (e.g., streaming media) is using cache proxies that are distributed near the network endpoints. The operators of such network cache proxies are known as a Content Delivery Network (CDN) or Edge Cache Network (ECN) providers. A CDN is a network of tiered cache nodes that can be used to distribute content delivery. A CDN is most commonly used to reduce the network bandwidth and load on an origin server (or servers) from which the content originates, increase the response time of content delivery, and reduce latency. A CDN tries to accomplish these objectives by serving the content from a cache node that is closest to a user that has requested the content. Each caching layer serves as a “filter” by caching and serving the requested content without having to go to the origin server (such as a web server) for every request. The Internet has built up a large infrastructure of routers and proxies that are effective at caching data for hypertext transfer protocol (HTTP). Servers can provide cached data to clients with less delay and by using fewer resources than re-requesting the content from the original source. For example, a user in New York may download a content item served from a host in Japan, and receive the content item through a router in California. If a user in New Jersey requests the same file, the router in California may be able to provide the content item without again requesting the data from the host in Japan. This reduces the network traffic over strained routes, and allows the user in New Jersey to receive the content item with less latency.

Pre-caching refers to caching content at a cache proxy before a client has requested the content. This is sometimes also referred to as warming up the caches. For content that is anticipated to have high demand, pre-caching can ensure that the earliest clients that request the content receive a nearby, cached version with low latency and without a catastrophic flood of bandwidth usage at the origin server. For example, if a DVD is being released tomorrow, then the same content can be made available online for those who would rather watch the DVD via the Internet (i.e., through video on demand). In anticipation for such demand, the CDN/ECN can pre-cache the DVD contents on its cache nodes.

Sometimes the load among cache proxies is further distributed to reduce the load on any particular cache server. For example, for a given body of content, each of three cache servers in a CDN may contain one-third of the content. The cache servers may also be arranged in a hierarchy so that cache servers at one level (a child cache proxy) receive requests from clients then request data unavailable in the cache from a next cache level (a parent cache proxy), and so forth. One protocol used by child proxies to determine at which parent cache proxy to access a particular content item is the Cache Array Routing Protocol (CARP). CARP works by generating a hash for each uniform resource locator (URL) used to reference content items. The protocol generates a different hash for each URL. By splitting the hash namespace into equal (or unequal parts, if uneven load is intended) the overall number of requests can be distributed to multiple servers. By sorting requests across cache proxies, CARP generally results in eliminating duplication of cache contents and improving global cache hit rates. CARP is often implemented by providing a text list (called the Proxy Array Membership Table) to each client (or child proxy) specifying the available cache proxies from which to retrieve content. The client can then use the hash function to determine to which cache proxy to route each request.

The use of pre-caching and CARP can lead to several challenges to cached content allocation and distribution, if applied incorrectly. In a multi-tier CDN, pre-caching at the parent level is often more desirable than pre-caching at each child. Pre-caching at child cache proxies can lead to prematurely consuming the client cache prior to an event. Disk space and other resource limitations at the child cache proxy may cause the child cache proxy to eject content that has been pre-cached before the event occurs. In addition, the content provider may overestimate the demand for content altogether or in certain regions so that efforts to pre-cache at particular child cache proxies are wasted. Thus, pre-caching at parent cache proxies is often helpful. Unfortunately, pre-caching at the parent cache proxy may lead to storing too much content, particularly in environments where CARP is used to divide responsibility for content among parent cache proxies.

### SUMMARY

A selective pre-caching system is described herein that reduces the amount of content cached at cache proxies to that content that a particular cache proxy is responsible for caching according to a routing function. This can substantially reduce the content stored on each cache proxy and reduces the amount of resources consumed for pre-caching in preparation for a particular event. In some embodiments, the cache proxy receives a list of content items and an indication of the topology of the cache network. Each cache proxy uses the deployment topology of cache proxies to determine which content each cache proxy is responsible for caching. The cache proxy then retrieves the determined content items and stores them in a cache (pre-caching) so that the content items are available in the cache before client requests are received. Thus, the selective pre-caching system efficiently pre-caches content items at each cache proxy.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the selective pre-caching system, in one embodiment.

FIG. 2 is a flow diagram that illustrates processing of the selective pre-caching system at a cache server in response to a request to pre-cache content, in one embodiment.

FIG. 3 is a flow diagram that illustrates processing of the content request component of the selective pre-caching system, in one embodiment.

FIG. 4 is a block diagram that illustrates processing of the selective pre-caching system at a conceptual level, in one embodiment.

### DETAILED DESCRIPTION

A selective pre-caching system is described herein that reduces the amount of content cached at cache proxies to that content that a particular cache proxy is responsible for caching according to a routing function. For example, if CARP is used by child cache proxies to select among multiple parent cache proxies to access content, then the selective pre-caching system provides information to the parent cache proxies to allow the proxies to determine which content child cache proxies will request from each parent cache proxy, and each parent cache proxy only caches content for which it may receive requests. This can substantially reduce the content stored on each cache proxy and reduces the amount of resources consumed for pre-caching in preparation for a particular event. In some embodiments, the process begins by a cache proxy receiving a list of content items that are potentially to be pre-cached. For example, the cache proxy may receive a list of URLs from an origin server or administrative tool. The cache proxy also receives an indication of the topology of the cache network. For example, the cache proxy may receive a text list of cache servers. The cache proxy uses the received topology to determine the content items in the received list of content items that the cache proxy is responsible for caching. For example, the cache proxy may perform a hash function on each URL in a list of content items and mark those items that hash to a value associated with the cache proxy. The cache proxy then retrieves the determined content items so that they are available in the cache before client requests are received. For example, the cache proxy may retrieve the items from a content server or a hierarchy level above the cache proxy in a CDN. Thus, the selective pre-caching system efficiently pre-caches content items at each cache proxy by only caching the contents for which each cache proxy is responsible.

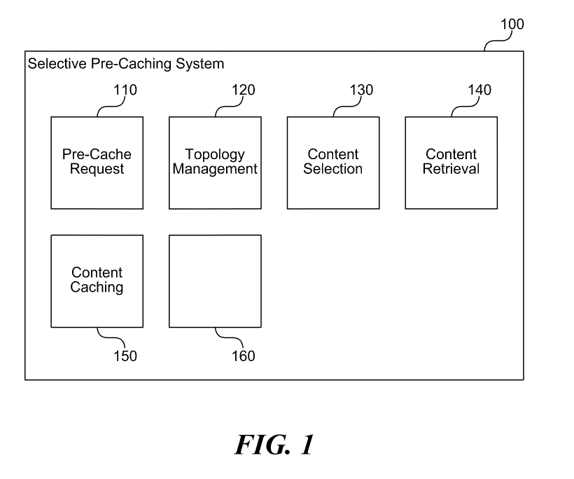

FIG. 1 is a block diagram that illustrates components of the selective pre-caching system, in one embodiment. The system 100 includes a pre-cache request component 110, a topology management component 120, a content selection component 130, a content retrieval component 140, a content caching component 150, and a content request component 160. Each of these components is described in further detail herein.

The pre-cache request component 110 receives requests to pre-cache content. For example, an administrator associated with an origin server or other part of a CDN may select content to pre-cache in an administrative tool, and the administrative tool may send pre-cache requests to one or more servers in the CDN. The pre-cache request may be an HTTP request to a prearranged URL at the cache server, or some other protocol for remotely making a request. The request may include parameters, such as a reference to a text file stored on the server from which the request was received. The parameters may include a list of URLs or other identifiers of content to pre-cache, as well as information about the layout of the CDN to which the cache server belongs.

The topology management component 120 manages knowledge of the layout of a network at a particular cache server. To determine the content that a particular cache server is responsible for caching, it may be relevant what other cache servers are available in a CDN and what content each server is assigned to cache. For example, an administrator may assign three parent cache servers to each cache one-third of a body of content (e.g., three each of nine URLs). The topology management component 120 may receive information about the topology of the network as a parameter to a received pre-cache request and may use one or more heuristics to determine the content that the server receiving the request is responsible for caching.

The content selection component 130 identifies a subset of content in a body of content that a particular cache server in a cache network of multiple cache servers is responsible for caching. Typically, a CDN is built with a particular architecture and distribution of servers that is anticipated to be able to handle expected loads. An administrator may determine a hierarchy of cache servers, and which servers in the hierarchy will manage what content. For example, a west coast cache server may be responsible for handling requests from the west coast of the United States. The caching for a particular area may be further distributed according to the configuration of the CDN. For example, rather than having each server cache the entirety of the content, potentially wasting disk space by storing redundant information on each cache server, the administrator may split responsibility for handling content requests among multiple cache servers, so that each cache server only stores a subset of the content. The content selection component 130 determines which content a particular cache server is responsible for caching in such a configuration. The content selection component 130 may invoke the topology management component 120 to determine a particular server's role in the CDN and may receive a list of content to pre-cache from the pre-cache request component 110.

The content selection component 130 may use CARP or other methods for identifying an appropriate subset of the content. To the extent that the cache server applies the same method of identifying the subset as a client will later apply to make a request, the cache server can determine the subset of content items that the cache server is responsible for caching. Because a CDN is typically planned out by a central authority or administrator, uniformity of behavior on the client and at the cache servers for directing requests for content can be achieved.

The content retrieval component 140 retrieves the identified subset of content associated with a pre-cache request. For example, an administrator may send a pre-cache request to multiple cache servers, and the request may include a list of URLs that make up a body of content to pre-cache. Each cache server examines the list and identifies those content items for which the cache server is responsible for handling client requests. For example, the cache server may be responsible for one-fourth of the URLs in the list. The content retrieval component 140 may make HTTP or other requests to retrieve the identified subset of content and store it locally at the cache server.

The content caching component 150 stores retrieved content in a data store. For example, the component 150 may receive retrieved content from the content retrieval component 140 and store the content on a local disk associated with a cache server. The data store may include a database, local or remote disk, storage area network (SAN), cloud based storage, and any other method of storing data. The content caching component 150 may store the data for a limited time or until the data is explicitly removed. Examples of limited time storage include many facilities well known in the art, such as storing data until an expiration time is passed, storing data until disk space is needed for storing new data, and so forth.

The content request component 160 receives requests to access content items, such as from a client or child cache server. The content request component 160 determines if a requested content item is stored in the content caching component 150. If the content item is available in the cache, then the content request component 160 typically responds by providing the cached item. If the content item is not in the cache (unlikely for content that is pre-cached), then the component 160 typically retrieves the item from a higher-level server (e.g., an origin server or parent cache), stores the item in the cache, then responds to the request by providing the content item. The content request component 160 may receive HTTP requests (e.g., GET and POST) or numerous other types of requests (e.g., file transfer protocol (FTP)).

The computing device on which the system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

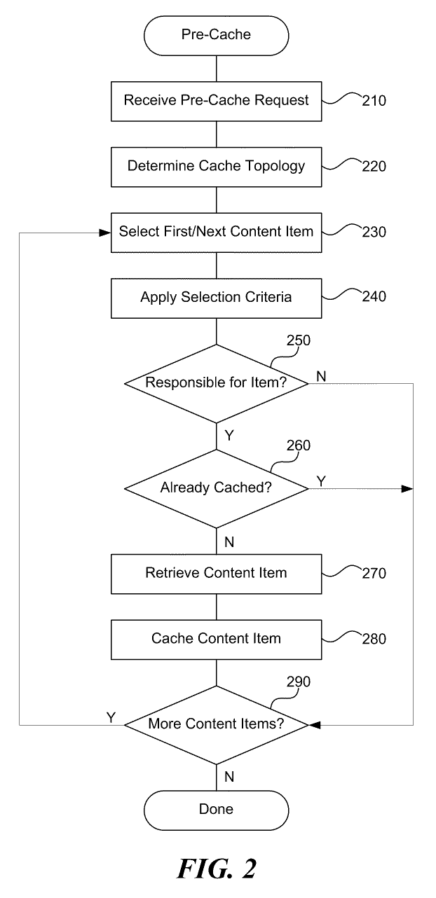

FIG. 2 is a flow diagram that illustrates processing of the selective pre-caching system at a cache server in response to a request to pre-cache content, in one embodiment. Beginning in block 210, the server receives a request to pre-cache content. Typically, the request originates from an administrator and is received by one or more parent cache proxies. The request may include parameters, such as a list of URLs and information about the configuration of cache proxies in a CDN. For example, the configuration information may indicate that content is split across three cache proxies at a particular level of a cache hierarchy. Continuing in block 220, the server determines a cache topology of multiple caches in a network. The server may identify the cache topology from the received request and use the topology to determine which content items the server is responsible for caching.

Continuing in block 230, the server selects a first content item associated with the received request. For example, if the request includes a list of URLs, then the server may select the first URL in the list. Continuing in block 240, the server applies one or more selection criteria to determine whether the server is responsible for caching the selected content item. For example, the server may apply CARP to compute a hash for the content item and determine whether the hash indicates the server is responsible for caching the item.

Continuing in decision block 250, if the server is responsible for caching the item, then the server continues at block 260, else the server jumps to block 290 to select the next item. This action can potentially save the cache server significant resources. By not caching those items that clients will not look to the present cache server to provide, the cache server avoids wasting disk space, bandwidth, and other resources pre-caching content for which it is not responsible. Continuing in decision block 260, the server determines if the selected content item is already cached by the server. If the selected item is not already cached, then the server continues at block 270, else the server jumps to block 290 to select a next content item. Continuing in block 270, the server retrieves the selected content item from a source location. For example, the content item may be identified by a URL, and the server may issue an HTTP GET request to retrieve the content associated with the URL from an origin server. The request may include information directing the cache server to a location from which the server can retrieve the content. The retrieval may also return information about the content item, such as how long the cache server should cache the item.

Continuing in block 280, the server stores the retrieved content item in a data store associated with the cache server. For example, the server may store the item as a file on a disk attached to the server. The server may also store information retrieved in association with the item, such as a cache expiration time. Continuing in decision block 290, if there are more content items, then the server loops to block 230 to select the next content item, else the server completes. After block 290, these steps conclude and the cache server has cached those content items associated with the received pre-cache request for which the cache server is responsible.

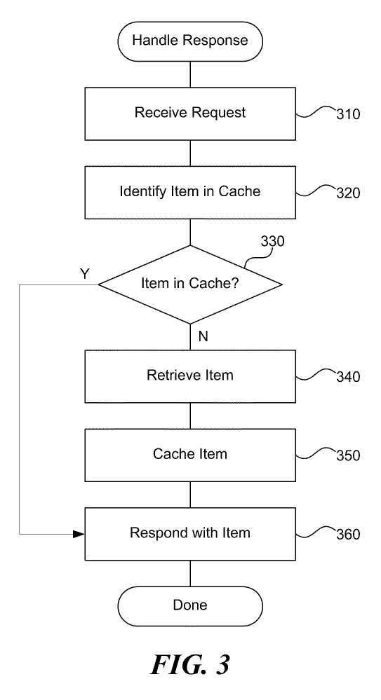

FIG. 3 is a flow diagram that illustrates processing of the content request component of the selective pre-caching system, in one embodiment. Beginning in block 310, the component receives a request to access a content item. For example, the request may come from a client computer attempting to playback a video stream or other content. The request may identify content in a variety of ways, such as through a URL used to access the content. The client may have selected the recipient of the request based on a caching algorithm, such as CARP. A cache server that receives the request and applies the system described herein may already have pre-cached the item requested, so that the item is available locally even if no one has requested the item before.

Continuing in block 320, the component determines whether the requested content item is available in a cache. For example, the component may access a local file system of a cache server to find a file representing the content item. Continuing in decision block 330, if the item is found in the cache, then the component jumps to block 360, else the component continues at block 340. Continuing in block 340, the component retrieves the item by requesting the item from a server. For example, if the present computer system is a child cache server, it may request the content item from a parent cache server. If the present computer system is a parent cache server, it may request the content item from an origin server.

Continuing in block 350, the component stores the retrieved content item in a local cache. The cache is a data store used for responding to future requests for the item without again retrieving the item from the server. Continuing in block 360, the component responds to the received request with the requested content item from the cache. For example, if the original request was an HTTP GET request, then the component provides a standard HTTP response (e.g., 200 OK) with the data of the content item. After block 360, these steps conclude.

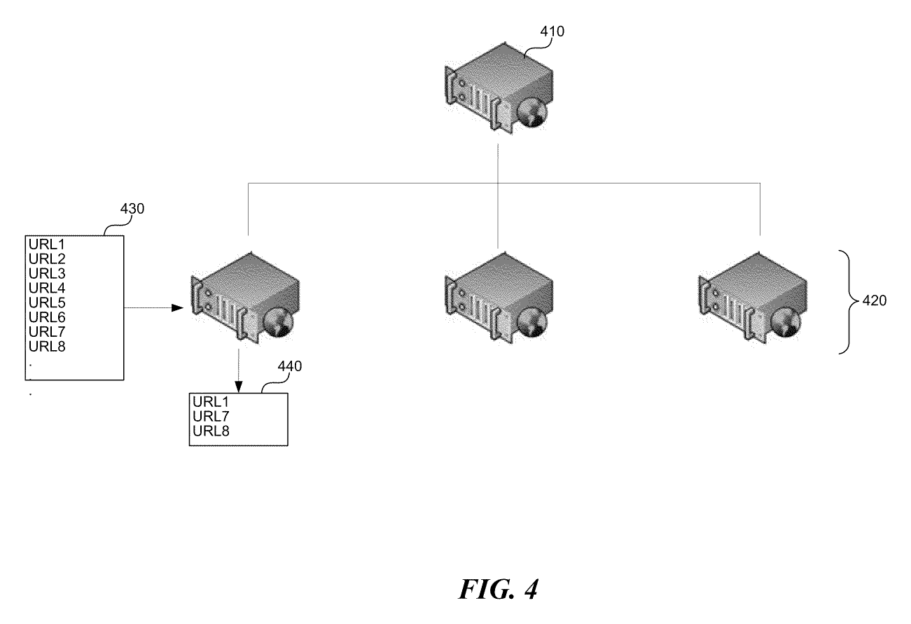

FIG. 4 is a block diagram that illustrates processing of the selective pre-caching system at a conceptual level, in one embodiment. The system may include at least one child cache server 410, and one or more parent cache servers 420. A content provider typically lays out a CDN according to the regions and demand expected for content served by the CDN, which may include a hierarchy of many cache servers. A parent cache server can be any cache server that provides content to another cache server, referred to as a child. A child cache server 410 may receive requests from clients or may receive requests from another layer of cache servers. The content may include a set of URLs 430 that clients can retrieve from the CDN. The child cache server 410 is configured to use CARP or another protocol to request URLs from the parent cache servers 420 in a deterministic manner. In other words, the child cache server 410 will request specific URLs 440 from a specific parent cache server.

The selective pre-caching system allows the parent cache servers 420 to avoid caching the entire set of URLs 430 on every parent cache server, increasing efficiency. Instead, each parent cache server caches a subset of URLs 440 for which the server is responsible for caching and which the child cache server 410 is expected to contact in case of a cache miss by the child cache server 410. To do this, each parent cache server performs a URL selection operation similar to that performed by the child cache server 410 to determine which of the parent cache servers 420 to which to send a particular request. The URL selection operation helps the parent cache server cull the list of URLs 430 down to the subset of URLs 440 for which that cache server is responsible, thereby saving disk space and other resources of the parent cache servers 420.

In some embodiments, child cache servers and parent cache servers using the selective pre-caching system apply a similar cache selection operation to select content. For example, a child cache may apply CARP to select a parent cache from which to access content, and the parent cache may apply CARP to a list of URLs to select the URLs for which the parent cache will receive requests. In this way, the parent selects content to pre-cache that is more likely to be useful to clients and avoids caching content that is not likely to be useful to clients of the parent cache.

In some embodiments, cache servers applying the selective pre-caching system provide a URL-based API for invoking pre-caching. For example, a server may expose a URL “.\pre-cache.sh” that, when invoked, causes the server to pre-cache content. The URL API may include parameters, such as “<list of URLs to cache>” and “<list of parent cache nodes>” that specify the list of URLs to potentially pre-cache and the list of other cache nodes, respectively. The list of other cache nodes lets a recipient of the pre-caching request know the topology of the cache network, at least at one level, so that the recipient can determine which URLs among the list of URLs the recipient is responsible for caching.

In some embodiments, the selective pre-caching system provides an administrative pre-caching command that pre-populates parent cache nodes with a set of content. Although it is possible to pre-cache at all cache nodes in a CDN, it may be more desirable to do so only at parent cache nodes for at least the following reasons. Pre-caching at the child cache nodes may lead to premature eviction of content. The child cache servers may have a much smaller storage reservoir and premature eviction negatively affects the performance of clients served by that child server. The actual child servers that will be in rotation when the pre-cached content “goes live” may very well be different from the child servers in rotation at the time of the pre-cache request. Many hours, and sometimes days, may elapse between the time of the pre-cache request and the time the content goes live. In addition, there may be a vast difference between the content that the content owner thinks will be popular and what will actually wind up being popular. Evicting content from child servers to make room for other content that may not actually be requested is not ideal. Finally, because of the time gap between the pre-cache request and go-live, it is possible that content pre-cached into child servers will itself be evicted before access, thus making the entire child cache operation ineffective. The system can avoid these problems to some degree by pre-caching at parent cache servers.

In some embodiments, the selective pre-caching system identifies content to pre-cache using a search engine optimization (SEO) tool. The SEO tool may watch the access patterns of a test client accessing a new body of content and determine the URLs or other content identifiers referenced to access the content. The system can then use the resulting list of URLs in a pre-cache request to cache servers when deploying the body of content for widespread consumption. Alternatively or additionally, the system may receive a list of URLs or other content identifiers from a content owner and pre-cache the received list of URLs.

In some embodiments, the selective pre-caching system pre-caches content based on a subscription or premium payment of a requestor. For example, a content owner may pay to continuously have his content pre-cached in particular CDN's cache servers. The content owner may be willing to pay to have the content available quickly when clients request the content. The system may initially cache the content and may run a script or other command to periodically re-cache the content in accordance with a subscription or other agreement with the content owner.

In some embodiments, the selective pre-caching system removes pre-cached content from cache servers over time based on a frequency of requests or expiration of the pre-cached content. The content owner may request that pre-cached content be available for a specific period during which the system does not evict the content from one or more cache servers. Alternatively or additionally, the system may evict content when the frequency of requests for the content falls below a certain threshold (e.g., content not requested for one week). This allows the CDN to effectively manage the use of cache server resources while keeping frequently requested content readily available. It also allows content owners to compensate the CDN operator for extra resources consumed by demands for content availability that may be contrary to the currently observed usage patterns of clients.

From the foregoing, it will be appreciated that specific embodiments of the selective pre-caching system have been described herein for purposes of illustration, but that various modifications may be made without deviating from the spirit and scope of the invention. For example although parent and child caches have been described at a single level, those of ordinary skill in the art will appreciate that network administrators can create deep, complex levels of caching to satisfy content delivery goals and the system described herein can be applied at many levels of such networks. Accordingly, the invention is not limited except as by the appended claims.

I/We claim:

1. A computer-implemented method for selectively pre-caching content, the method comprising:
receiving at a cache proxy server a request to pre-cache one or more content items;
determining a cache topology of multiple cache proxy servers connected by a network;
selecting a content item associated with the received request;
applying one or more selection criteria to determine whether the cache proxy server is responsible for caching the selected content item;
upon determining that the cache proxy server is responsible for caching the selected content item,
retrieving the selected content item from a source location; and
storing the retrieved content item in a data store associated with the cache proxy server,
wherein the preceding steps are performed by at least one processor.

2. The method of claim 1 wherein receiving a request to pre-cache one or more content items comprises receiving parameters that include a list of cache items and a list of peer cache servers.

3. The method of claim 1 wherein determining the cache topology comprises receiving a list of cache servers associated with the request.

4. The method of claim 1 wherein selecting the content item comprises selecting a uniform resource locator (URL) from a list of URLs associated with the received request.

5. The method of claim 1 wherein applying one or more selection criteria comprises applying the determined cache topology to determine which content items the cache proxy server is responsible for caching.

6. The method of claim 1 wherein applying one or more selection criteria comprises applying the Cache Array Routing Protocol (CARP) to generate a hash of a content identifier associated with the selected content item.

7. The method of claim 1 further comprising avoiding caching at least one content item for which applying the one or more selection criteria determines that the cache proxy server is not responsible for caching the at least one content item.

8. The method of claim 1 wherein retrieving the selected content item comprises retrieving the content item from an origin server that the cache proxy server protects by handling at least some requests that the origin server would otherwise receive.

9. The method of claim 1 wherein retrieving the selected content item comprises receiving information describing a requested period for caching the selected content item.

10. The method of claim 1 wherein storing the retrieved content item comprises storing the item so that the item can be accessed locally from the cache proxy server in response to a received request to retrieve the content item.

11. A computer system for selectively pre-caching content, the system comprising:
a processor and memory configured to execute software instructions;
a pre-cache request component configured to receive one or more requests to pre-cache content at a cache proxy server in a cache network of multiple cache proxy servers;
a topology management component configured to manage knowledge of the layout of a network of cache servers of which the cache proxy server is a member;
a content selection component configured to identify a subset of the content that the cache proxy server is responsible for caching within the network of multiple cache proxy servers;
a content retrieval component configured to retrieve the identified subset of the content associated with a pre-cache request;
a content caching component configured to store retrieved content in a data store associated with the cache proxy server; and
a content request component configured to receive requests to access content items stored by the content caching component.

12. The system of claim 11 wherein the pre-cache request component is further configured to receive requests from an administrative tool used by an administrator of a content delivery network (CDN) to pre-cache content.

13. The system of claim 11 wherein the pre-cache request component is further configured to expose an application programming interface (API) for pre-caching content using a predetermined uniform resource locator (URL) to which the cache proxy server responds.

14. The system of claim 11 wherein the pre-cache request component is further configured to receive parameters containing information related to the received requests.

15. The system of claim 11 wherein the topology management component is further configured to receive network topology information from the pre-cache request component based on parameters associated with one or more received requests.

16. The system of claim 11 wherein the content selection component invokes the topology management component and uses the Cache Array Routing Protocol (CARP) to determine whether the cache proxy server is responsible for handling requests for a particular uniform resource locator (URL).

17. The system of claim 11 wherein the content caching component is further configured to remove retrieved content from the data store based on one or more expiration criteria.

18. The system of claim 11 wherein the content caching component is further configured to apply subscription information associated with a content owner to determine a period to cache content provided by the content owner.

19. A computer-readable storage medium comprising instructions for controlling a computer system to respond to a request to access a pre-cached content item, wherein the instructions, when executed, cause a processor to perform actions comprising:
receiving at a cache server a request to access a content item;
determining that the requested content item is available in a cache of items requested to be stored prior to client requests by an administrative request to the cache server; and
responding to the received request with the requested content item from the cache without contacting an origin server of the requested content item.

20. The medium of claim 19 wherein receiving a request to access a content item comprises receiving a request from a client that applies a cache selection heuristic to select a cache server related to a cache selection heuristic applied by the cache server to select content to cache.
